(19) United States
(12) Patent Application Publication
(10) Pub. No.: US 2006/0095548 A1
(43) Pub. Date: May 4, 2006

(54) Method for the automatic selection of a security configuration for terminals of nomad users

(76) Inventors: Wilfrid Rabot, Cresserons (FR); Ivan Lovric, Lunel (FR); Pierre Cazenave, Eterville (FR)

Correspondence Address: FISH & RICHARDSON P.C., P.O. BOX 1022, MINNEAPOLIS, MN, 55440-1022, US

(21) Appl. No.: 11/241,017

(22) Filed: Sep. 30, 2005

(30) Foreign Application Priority Data
Oct. 1, 2004 (FR) 0410400

(51) Int. Cl. G06F 15/177

(52) U.S. Cl. 709/220

(57) ABSTRACT

Method for selecting a security configuration of a user's terminal (10) able to be connected to at least one network (1, 2) via several network interfaces, comprising steps during which the terminal (10): detects any change in the terminal's physical connection to a network; verifies that the terminal is connected to a network by a unique physical link; disconnects all physical links with a network so as to maintain only one physical link; determines the characteristics of the maintained physical link; and configures the terminal in relation to the characteristics of the maintained physical link.

The present invention relates to the protection of terminals when they are connected to a private or public computer network, such as the Internet.

It applies particularly, but not exclusively, to terminals of nomad users, irrespective of the network to which they are connected, the connection mode and the type of terminal. Hence the network may be of Ethernet, WiFi, GPRS (General Packet Radio Service), ADSL (Asymmetric Digital Subscriber Line), PSTN (Public Switched Telephone Network) type, . . . , the connection mode may be of wire or wireless type (Bluetooth for example) with or without intermediate proxy, and the terminal may be of PC, PDA type, . . . .

At the current time, nomad users have increasingly more network connection means. With the development of wireless networks such as WiFi and Bluetooth, nomad user terminals generally have several network interfaces which may be activated simultaneously. In addition, some of these network interfaces may connect automatically, for example on start-up of the terminal with no particular action on the user's part. As a result the security of said terminals is affected.

To overcome this drawback, users must permanently and manually check the uniqueness of their network connection.

In general, the security of a terminal is ensured by what is called a firewall which in some situations, nomad situations in particular, must be configured manually by the user and activated or deactivated depending on whether or not the terminal is connected to a secure environment.

The most frequent case occurs with users having a laptop which they can use at their usual workplace or outside thereof. For this purpose, the laptop has an Ethernet network interface (wireline) or a WiFi interface with which to connect to a local network, the local network itself being connected to a public IP network such as the Internet via a proxy and a firewall. When users have nomad status (outside their usual workplace) they can connect to the Internet via the WiFi interface and firewall software installed in the laptop.

At the current time, whenever users leave their office and access the Internet under nomad status, or return to their office, they must manually configure their network interface cards, firewall and proxy parameters of their navigator. This leads to major risks of error which could have serious consequences if the security functions are not correctly activated or if the terminal is connected to the Internet simultaneously via a secure local network and a WiFi interface. Configuration errors may also prevent the terminal from connecting to the local network or Internet, or from being remotely updated (software and anti-virus updates) when connected to a secure local network. Such configuration errors may also involve dysfunction of the web browser (wrong configuration of proxy parameters) making Internet connections impossible and having the consequences of time losses and unnecessary calls to computer assistance services.

The situation becomes further complicated if the user's terminal has more than two network interfaces, each interface then being associated with a respective network environment and security configuration consisting of a set of configuration parameters, firewall parameters in particular.

The present invention sets out to overcome these drawbacks and in particular to securitize the terminal's network connection.

For this purpose, the invention proposes a method comprising steps during which the terminal:
verifies whether the terminal is connected to a network by a unique physical link,
if uniqueness of connection is not verified, disconnects all physical links with a network so as to maintain only one physical link,
determines the characteristics of the maintained physical link, and
configures the terminal in relation to the characteristics of the maintained physical link.

Advantageously, an order of priority is allocated to each of the possible physical links of the terminal with a network, the maintained physical link having highest priority.

According to a preferred embodiment of the invention, if a physical link with a network cannot be disconnected, the terminal emits an alert message to the user and configures the terminal taking active physical links into account.

According to a preferred embodiment of the invention, the determination of the characteristics of a physical link with a network comprises an identification step of a possible local network to which the active network interface is connected, by attempting connection to a secure server known to the terminal and supposedly visible solely to the local network.

According to a preferred embodiment of the invention, the configuration of the terminal consists of selecting a set of parameter values corresponding to the maintained network link.

According to a preferred embodiment of the invention, the step consisting of verifying whether the terminal is connected to the network via a unique link is preceded by a detection step to detect a change in physical connection of the terminal to a network.

According to one variant, the detection step is triggered periodically.

According to another variant, the detection step is triggered on receipt of a system event.

The invention also concerns an automatic configuration programme of the security of a terminal able to be connected to at least one network via several network interfaces, this programme comprising programme code instructions to carry out the above-defined method when the programme is executed on a terminal.

The invention also concerns a terminal containing said programme.

The invention also concerns a nomad user's terminal comprising at least two network interfaces to connect to at least one network, a firewall and navigational software. According to the invention, this terminal comprises programmed processing means to:
verify that the terminal is connected to a network by a unique physical link,
if uniqueness of connection is not verified, disconnect all physical links with a network so as to maintain only one physical link,
determine the characteristics of the maintained physical link, and
configure the terminal in relation to the characteristics of the maintained physical link.

Advantageously, the processing means are programmed to allocate an order of priority to each of the possible network links of the terminal, the maintained network link being giving highest priority.

According to a preferred embodiment of the invention, the processing means are programmed to emit an alert message to the user if a physical link cannot be disconnected, and to configure the terminal taking several active physical links into consideration.

According to a preferred embodiment of the invention, the processing means are programmed to identify a possible local network to which the active network interface is connected, by conducting an attempted connection to a secure server known to the terminal and supposedly visible solely to the local network.

A preferred embodiment of the invention is described below as a non-restrictive example with reference to the appended drawings in which:

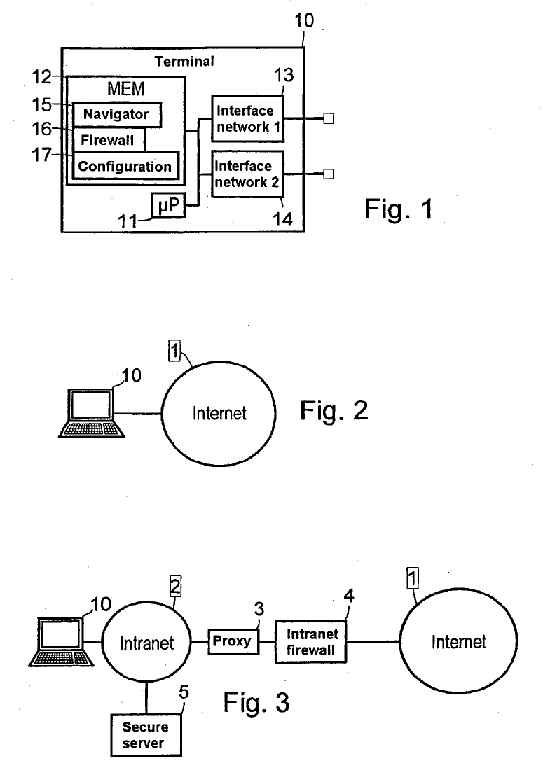

FIG. 1 is a schematic of a nomad terminal;

FIG. 2 is a schematic of the environment of the terminal shown in FIG. 1, connected to a public network;

FIG. 3 is schematic of the environment of the terminal shown in FIG. 1 when it is connected to the same public network via a private local network;

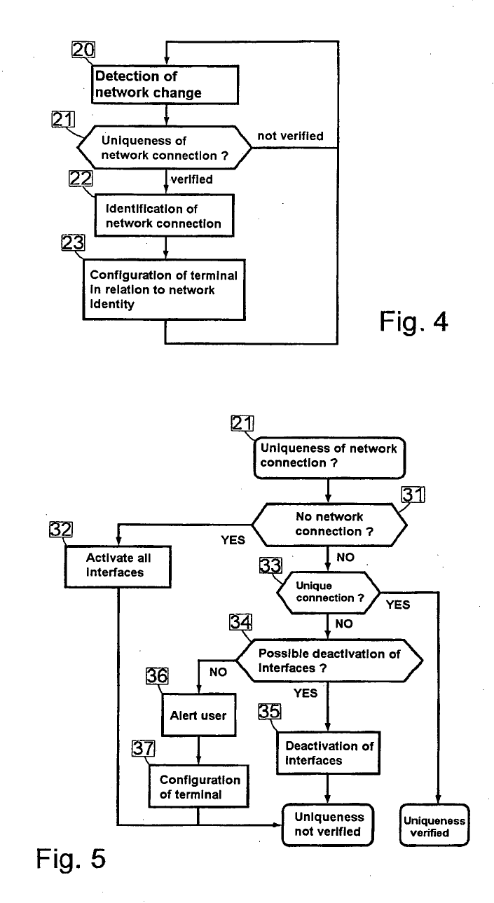

FIG. 4 is a flow chart of the different steps of the method in accordance with the invention,

FIG. 5, in more detail in the form of a flow chart, shows one of the steps of the method illustrated FIG. 4.

FIG. 1 shows a terminal 10 for example of laptop type or personal electronic assistant (PDA) type comprising several network interfaces 13, 14 to connect in different ways to a network such as the Internet, a processor 11, data and programme memories 12 memorising a web browser 15, and a firewall 16 for protection against intruder attempts from the network.

The network interfaces 13, 14 may be of Ethernet network card type, modem (ADSL, PSTN, GPRS), WiFi interface, Bluetooth interface, etc. These interfaces may also be of the same type. Therefore the terminal may for example comprise two WiFi interfaces and one PSTN modem.

With this configuration terminal 10 can for example be connected directly to a public network 1 such as the Internet as illustrated FIG. 2, or via a local network 2 as illustrated FIG. 3. Such connection can be either physical using a physical interface, or virtual to obtain an advanced service (virtual private network . . . ) on one or more physical connections.

In FIG. 3, terminal 10 is connected to a private local network 2 such as a local company network or Intranet, this network itself being connected to the public network 1 via a proxy 3 and a firewall 4. The connection between the terminal and the local network is conventionally made via an Ethernet interface.

Changing between the configurations illustrated FIGS. 2 and 3 requires configuration of the network interfaces 13, 14 installed in the terminal, of the firewall 16 and of the proxy parameters of the web brower 15.

For this purpose, terminal 10 is equipped, according to the invention, with an automatic configuration device 17, advantageously in the form of a programme designed to verify permanently that the terminal is connected to a network 1, 2 by a unique physical link, to determine the type of network to which the terminal is so connected and to select a security configuration in relation to the network and the type of link with this network.

As illustrated FIG. 4, the configuration device 17 is designed to detect a change in physical connection to a network, and on each detection of said change to execute a procedure 20 comprising execution of a verification procedure 21 verifying that the terminal 10 is connected to a network 1 by a unique physical link. If uniqueness of the network connection is not verified, the device again executes procedure 20. If not the device identifies the physical connection at the next step 22, then at following step 23 configures the terminal in relation to the type of physical connection identified during the previous step.

Detection of a change in physical connection to a network consists of determining changes in the connected/disconnected status of the network interfaces of terminal 10. This detection may be performed by verifying the connected/disconnected status of the network interfaces which can be triggered either periodically or on receipt of a system event (such as a change in IP address).

Verification of the uniqueness of the. terminal's physical connection to a network consists of verifying that a single physical connection is active on the terminal at a given time. This verification consists of applying the following rules:
if no physical connection is active, all the network interfaces are activated,
when two network interfaces are detected as being simultaneously connected, the device attempts to disable the network interfaces defined as having lower priority.

An example of procedure 21 for verifying uniqueness of the physical connection is illustrated FIG. 5. In this figure, during a first step 31 the procedure tests whether a network interface of the terminal is active. If no network interface is active, all the network interfaces are activated at step 32 and procedure 21 ends by feeding back that uniqueness of the network connection is not verified. If at step 31 at least one network interface is active, the procedure tests at step 33 whether several network interfaces are active. If only one network interface is active, procedure 21 ends by feeding back that uniqueness of the physical connection with a network is verified. If not, procedure 21 attempts at step 34 to disable the network interfaces having least priority so as only to maintain the one with the highest priority.

The order of priority of the physical connections may be chosen as follows:
1. connection via a modem (STN, GPRS, ADSL),
2. connection via an Ethernet wire link,
3. connection via a WiFi link,
4. connection via a Bluetooth link.

All these connections may be disable with the exception of the connections via modem. Therefore if the user sets up several connections with modems, the procedure alerts the user (step 36) that several modems are simultaneously connected, and configures the terminal to ensure the greatest security (activation of the local firewall 16) having regard to these connections (step 37).

In the other cases, solely the physical connection having highest priority is maintained (step 35). In particular, if terminal 10 is connected to the network via the WiFi interface, a physical connection via the Ethernet wire link causes disabling of the WiFi link. Procedure 21 then ends by feeding back that uniqueness of the physical connection is not verified.

Identification of the network connected to the physical interface (step 22) is performed in securitized manner using authentication parameters for access to the network (802, 1x, . . . ) or by attempting connection to a server accessible solely in the local network using a secure protocol (SSL, HTTPS, . . . ).

For example, as shown FIG. 2, an HTTPS server 5 visible only in the local network 2 may be used to identify this network: if the address of the server 5, known to the terminal, effectively gives access to a server and if this access is secure (server authentication) then the terminal is indeed connected to the local network 2.

The configuration of terminal 10 in relation to the network and/or network interface (step 23) consists of selecting a security configuration (activation/configuration of a firewall, setting up a connection of virtual private network type . . . ) and of configuring other applications non-related to security but depending upon the connected local network, such as the terminal's navigator (navigator's proxy parameter). The terminal therefore memorizes a configuration (set of values for security parameters and configuration) for each possible terminal link with the public network 1.

1. Method of selecting a security configuration for a user's terminal able to be connected to at least one network by several network interfaces,
characterized in that it comprises steps during which the terminal;
verifies whether the terminal is connected to a network by a unique physical link,
if uniqueness of connection is not verified, disconnects all physical links with a network so as to maintain only one physical link,
determines the characteristics of the maintained physical link, and
configures the terminal in relation to the characteristics of the maintained physical link.

2. Method as in claim 1,
characterized in that an order of priority is allocated to each of the possible physical links of the terminal with a network, the maintained physical link having highest priority.

3. Method as in claim 1,
characterized in that if a physical link with a network cannot be disconnected, the terminal emits an alert message to the user and configures the terminal taking the active physical links into account.

4. Method as in claim 1,
characterized in that determination of the characteristics of a physical link with a network comprises an identification step of a possible local network to which the active network interface is connected, by attempting connection to a secure server known to the terminal and supposedly visible solely to the local network.

5. Method as in claim 1,
characterized in that the configuration of the terminal consists of selecting a set of parameter values corresponding to the maintained network link.

6. Method as in claim 1 wherein the step consisting of verifying whether the terminal is connected to the network via a unique link is preceded by a detection step to detect a change in physical connection of the terminal to a network.

7. Method as in claim 6, wherein the detection step is triggered periodically.

8. Method as in claim 1, wherein the detection step is triggered on receipt of a system event.

9. Automatic configuration program of the security of a terminal able to be connected to at least one network via several network interfaces characterized in that it comprises program code instructions to carry out the method as in claim 1 when the program is executed on a terminal.

10. Terminal comprising the program as in claim 9.

11. Nomad user's terminal comprising at least two network interfaces to connect to at least one network, a firewall and navigational software,
characterized in that it comprises processing means programmed to:
verify whether the terminal is connected to a network by a single physical link,
if uniqueness of connection is not verified, disconnect all physical links with a network so as to maintain only one physical link,
determine the characteristics of the maintained physical link, and
configure the terminal in relation to the characteristics of the maintained physical link.

12. Terminal as in claim 11,
characterized in that the processing means are programmed to allocate an order of priority to each of the possible network links of the terminal, the maintained network link having highest priority.
